(19) United States
(12) Patent Application Publication
(10) Pub. No.: US 2013/0141892 A1
(43) Pub. Date: Jun. 6, 2013

(54) LAMP AND LIGHTING APPARATUS

(71) Applicants: Toru Okazaki, Osaka (JP); Atsushi Motoya, Shiga (JP)

(72) Inventors: Toru Okazaki, Osaka (JP); Atsushi Motoya, Shiga (JP)

(73) Assignee: PANASONIC CORPORATION, Osaka (JP)

(21) Appl. No.: 13/817,031

(22) PCT Filed: Dec. 20, 2011
(86) PCT No.: PCT/JP2011/007138

§ 371 Date: Feb. 14, 2013

(30) Foreign Application Priority Data
Jan. 14, 2011 (JP) 2011-006415

(51) Int. Cl. F21V 29/00

(52) U.S. Cl. CPC F21V 29/2206
USPC 362/84; 362/363

(57) ABSTRACT

Provided is a lamp capable of suppressing an increase in temperature of a semiconductor light-emitting device, such as LED. A lamp according to the present invention is a lamp in which gas is enclosed, the lamp includes: a globe; and a light-emitting module which is housed in the globe and includes a base board and an LED disposed on the base board. The gas in the lamp is enclosed in the globe, the gas surrounding the light-emitting module and containing one of hydrogen, helium, and nitrogen.

### TECHNICAL FIELD

The present invention relates to lamps and lighting apparatuses, and particularly relates to a lamp and others using a semiconductor light-emitting device, such as a light-emitting diode (LED).

### BACKGROUND ART

In recent years, semiconductor light-emitting devices such as LEDs are used for various lamps as highly efficient space-saving light sources. In particular, research and development has been taking place on LED lamps using LEDs as the lighting replacing conventional fluorescent light and incandescent light bulb. An LED lamp having the shape of light bulb (light bulb shaped LED lamp) has been proposed as lighting replacing the light bulb shaped fluorescent light and incandescent light bulb. Furthermore, a straight-tube shaped LED lamp (straight-tube LED lamp) has been proposed as the lighting replacing the straight-tube fluorescent light.

Examples of this type of LED lamps include a conventional light bulb shaped LED lamp disclosed in the patent literature (PTL) 1, and conventional straight-tube LED lamp disclosed in PTL 2. LED modules each including a base board on which LEDs are mounted are used for these LED lamps.

### CITATION LIST

### Patent Literature

### [PTL 1]

Japanese Unexamined Patent Application Publication No. 2006-313717

### [PTL 2]

Japanese Unexamined Patent Application Publication No. 2009-043447

### SUMMARY OF INVENTION

### Technical Problem

However, in the conventional LED lamp, heat is generated from an LED when the LED emits light. This raises the temperature of the LED, causing problems that LED has reduced light output and shorter lifetime.

The present invention has been conceived in order to solve the problems, and an object of the present invention is to provide a lamp and a lighting apparatus capable of reducing increase in temperature of the semiconductor light-emitting device, such as an LED.

### Solution to Problem

In order to solve the above problems, a lamp according to an aspect of the present invention is a lamp in which gas is enclosed, the lamp includes: a housing; and a light-emitting module which is housed in the housing and includes a base board and a semiconductor light-emitting device disposed on the base board, wherein the gas is enclosed in the housing, the gas surrounding the light-emitting module and containing at least one of hydrogen, helium, and nitrogen.

According to this aspect, gas containing at least one of hydrogen, helium, and nitrogen is enclosed in the housing. With this, the heat generated by the light-emitting module is efficiently conducted and radiated to the gas inside the housing. In this manner, the heat generated by the light-emitting module can be efficiently conducted to the housing through the gas, and dissipated to outside of the lamp.

Furthermore, in an aspect of the lamp according to the present invention, it is preferable that the base board be translucent.

According to this aspect, the base board of the light-emitting module is translucent. Thus, the light emitted by the semiconductor light-emitting device passes through the base board. With this, the light-emitting module can emit light not only from the surface on which the semiconductor light-emitting device is mounted but also from the surface opposite the surface on which the light-emitting device is mounted, and thus can emit light omnidirectionally. Thus, it is possible to achieve an omnidirectional light distribution property similar to the omnidirectional light distribution property of the conventional incandescent light bulb.

Furthermore, in an aspect of the lamp according to the present invention, it is preferable that the lamp include a sealing member which seals the semiconductor light-emitting device, wherein the sealing member includes a first wavelength conversion material for converting a wavelength of light emitted by the semiconductor light-emitting device to a predetermined wavelength.

According to this aspect, the wavelength of light emitted by the semiconductor light-emitting device can be converted to a predetermined wavelength.

Furthermore, in an aspect of the lamp according to the present invention, it is preferable that the lamp include a wavelength conversion member for converting the wavelength of the light emitted by the semiconductor light-emitting device to the predetermined wavelength, wherein the wavelength conversion member is formed on a surface of the base board opposite a surface on which the semiconductor light-emitting device is disposed.

According to this aspect, the wavelength of light transmitted through the base board among the light emitted by the semiconductor light-emitting device can be converted to a predetermined wavelength by the wavelength conversion member. With this, it is possible to emit light of the desired color from both surfaces, namely, the surface on which the semiconductor light-emitting device is mounted and the opposite surface.

Furthermore, in an aspect of the lamp according to the present invention, it is preferable that the wavelength conversion member be a sintered-material film, and the sintered-material film include (i) a second wavelength conversion material for converting a wavelength of light transmitted through the base board among the light emitted by the semiconductor light-emitting device to the predetermined wavelength and (ii) a binder for sintering made of an inorganic material.

According to this aspect, the wavelength of light transmitted through the base board among the light emitted by the semiconductor light-emitting device can be converted to a predetermined wavelength by the sintered-material film.

Furthermore, in an aspect of the lamp according to the present invention, it is preferable that the lamp include a groove formed on the surface of the base board on which the semiconductor light-emitting device is disposed, the groove holding a third wavelength conversion material for converting the wavelength of the light emitted by the semiconductor light-emitting device to the predetermined wavelength.

According to this aspect, the wavelength of light emitted through a side surface of the base board among the light emitted by the semiconductor light-emitting device can be converted to a predetermined wavelength by the third wavelength conversion material held in the groove. With this, the light emitted omnidirectionally from the base board can have the desired color.

Furthermore, in an aspect of the lamp according to the present invention, it is preferable that the lamp include a heat sink fixed to the base board.

According to this aspect, the light-emitting module includes a heat sink. Thus, the heat generated by the light-emitting module is conducted to the heat sink, and then to the gas from the heat sink. With this, the heat generated by the light-emitting module can be conducted to the housing more efficiently.

Furthermore, in an aspect of the lamp according to the present invention, it is preferable that the base board be provided standing on the heat sink.

According to this aspect, the predetermined light from the LED module can be emitted mainly in a direction toward the lateral part of the housing. In this case, the base board may include a plurality of base boards.

Furthermore, in an aspect of the lamp according to the present invention, it is preferable that the heat sink be fixed to a surface of the base board opposite a surface on which the semiconductor light-emitting device is disposed.

According to this aspect, the heat sink can be disposed in the lamp without affecting the light emitted from the surface of the base board on which the semiconductor light-emitting device is arranged. This makes it possible to reduce deterioration of the light distribution property caused by the heat sink.

Furthermore, in an aspect of the lamp according to the present invention, it is preferable that the lamp include a power receiving unit configured to receive power for causing the light-emitting module to emit light, wherein the heat sink extends toward the power receiving unit.

According to this aspect, the heat conducted to the heat sink can be dissipated to outside of the lamp through the power receiving unit.

Furthermore, in an aspect of the lamp according to the present invention, it is preferable that the heat sink include a heat dissipation fin.

According to this aspect, the heat sink includes the heat dissipation fin, and thus the heat conducted to the heat sink can be efficiently conducted to the gas inside the housing.

Furthermore, in an aspect of the lamp according to the present invention, it is preferable that the heat sink be translucent.

According to this aspect, deterioration of the light distribution property caused by the heat sink can be reduced because the heat sink is translucent.

Furthermore, in an aspect of the lamp according to the present invention, it is preferable that the lamp be a light bulb shaped lamp, further including a lead wire which supplies power to the light-emitting module and supports the light-emitting module.

According to this aspect, the light-emitting module is supported by the lead wire, and thus a supporting member dedicated to supporting the light-emitting module does not have to be specially provided. This makes it possible to reduce deterioration of the light distribution properly caused by the supporting member.

Furthermore, in an aspect of the lamp according to the present invention, it is preferable that the lamp be a straight-tube lamp, further including a supporting member which supports the light-emitting module.

According to this aspect, it is easy to dispose the light-emitting module in the housing because the light-emitting module is supported by the supporting member.

Furthermore, an aspect of the lighting apparatus according to the present invention is the lighting apparatus which includes any one of the lamps described above.

The present invention can be realized not only as the above-described lamp, but also as the lighting apparatus including any one of the lamps described above.

### Advantageous Effects of Invention

According to the present invention, the increase in temperature of the semiconductor light-emitting device can be reduced.

### BRIEF DESCRIPTION OF DRAWINGS

FIG. 1 FIG. 1 is an external perspective view of a lamp 100 according to Embodiment 1 of the present invention.

FIG. 2 is an exploded perspective view of the lamp 100 according to Embodiment 1 of the present invention.

FIG. 3 is a front view of the lamp 100 according to Embodiment 1 of the present invention.

FIG. 4A is a cross-sectional view of an LED module 20 in the lamp 100 according to Embodiment 1 of the present invention.

FIG. 4B is a partial enlarged cross-sectional view (region A enclosed by a broken line in FIG. 4A) of the LED module 20 in the lamp 100 according to Embodiment 1 of the present invention.

FIG. 5 is a front view of the lamp 200 according to Embodiment 2 of the present invention.

FIG. 6 is a cross-sectional view of an LED module 220 in the lamp 200 according to Embodiment 2 of the present invention.

FIG. 7A is a cross-sectional view of an LED module 220A in a lamp according to a variation of Embodiment 2 of the present invention.

FIG. 7B is a plan view of the LED module 220A in the lamp according to Embodiment 2 of the present invention.

FIG. 8 is an external perspective view of a lamp 300 according to Embodiment 3 of the present invention.

FIG. 9 is a front view of the lamp 300 according to Embodiment 3 of the present invention.

FIG. 10 is a front view of a lamp 300A according to Variation 1 of Embodiment 3 of the present invention.

FIG. 11 is a front view of a lamp 300B according to Variation 2 of Embodiment 3 of the present invention.

FIG. 12 is a front view of a lamp 300C according to Variation 3 of Embodiment 3 of the present invention.

FIG. 13 is a diagram for describing experimental results on lamps according to embodiments of the present invention (a diagram showing relationship between luminous flux and power supplied to LED modules).

FIG. 14 is a diagram for describing experimental results on lamps according to embodiments of the present invention (a diagram showing relationship between junction temperatures of LEDs and power supplied to LED modules).

FIG. 15 is a schematic cross-sectional view of a lighting apparatus 400 according to an embodiment of the present invention.

FIG. 16 is an enlarged view of a major part of a lamp 300D according to Variation 1 of the present invention.

FIG. 17 is an enlarged view of a major part of a lamp 300E according to Variation 2 of the present invention.

FIG. 18 is an enlarged view of a major part of a lamp 300F according to Variation 3 of the present invention.

FIG. 19 shows a top view and a perspective view which schematically show a configuration of a lamp 600 according to Variation 4 of the present invention.

### DESCRIPTION OF EMBODIMENTS

The following shall describe a lamp and a lighting apparatus according to embodiments of the present invention with reference to the drawings. Note that, the diagrams are schematic diagrams, and illustration is not necessarily strictly accurate.

### Embodiment 1

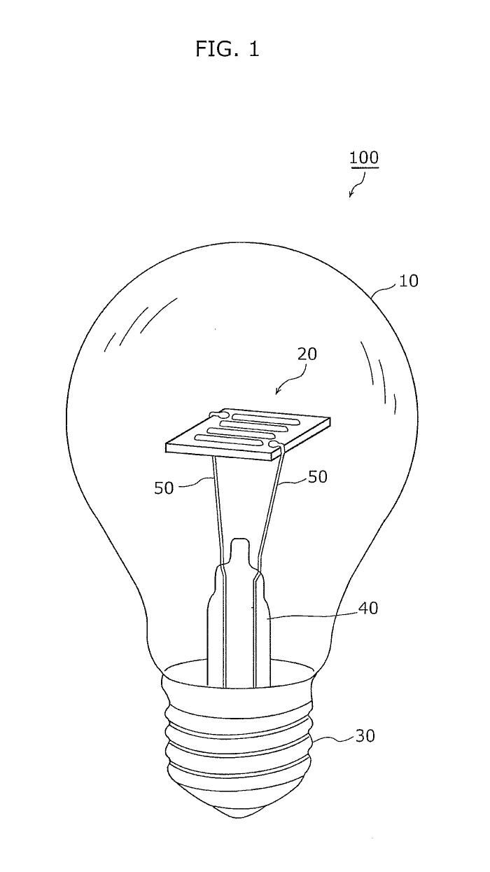

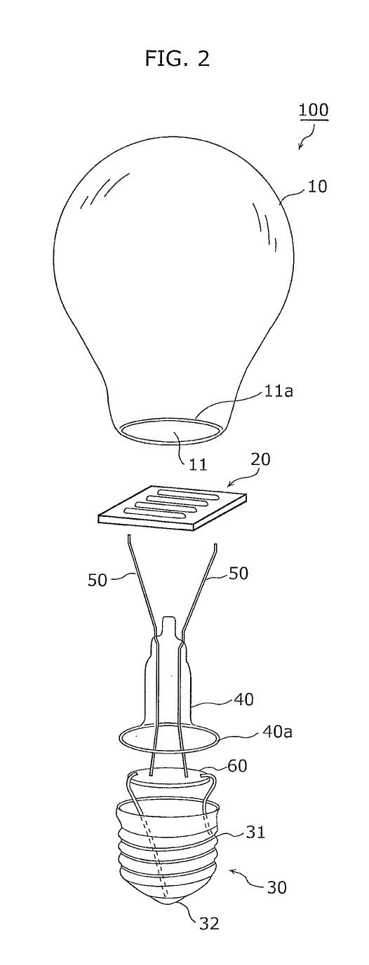

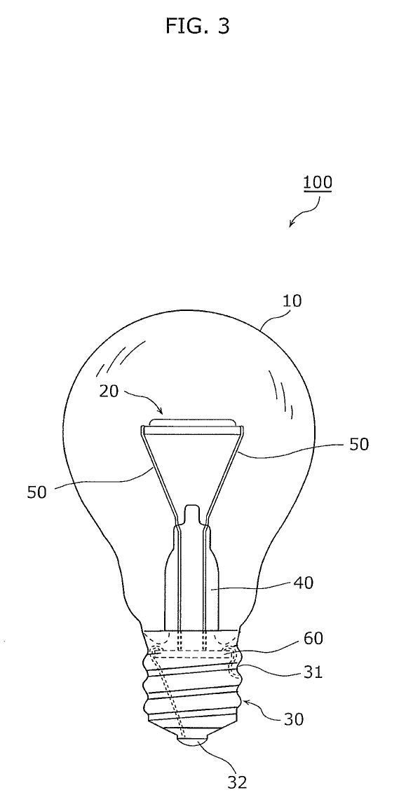

First, a lamp 100 according to Embodiment 1 of the present invention is described with reference to FIG. 1 to FIG. 3. FIG. 1 is an external perspective view of the lamp 100 according to Embodiment 1 of the present invention. FIG. 2 is an exploded perspective view of the lamp 100 according to Embodiment 1 of the present invention. FIG. 3 is a front view of the lamp 100 according to Embodiment 1 of the present invention.

As shown in FIG. 1 to FIG. 3, the lamp 100 according to Embodiment 1 of the present invention is a light bulb shaped LED lamp replacing conventional incandescent light bulb, and includes a translucent glob 10, an LED module 20, a base 30 for receiving power, a stem 40, lead wires 50, and a lighting circuit 60.

The lamp 100 according to this embodiment includes a lamp envelope which includes the globe 10 and the base 30. A predetermined gas is enclosed in the lamp 100, and the lamp 100 is sealed. In other words, the lamp 100 has a configuration which prevents the predetermined gas enclosed in the lamp 100 from leaking to the outside of the lamp 100.

The following describes in detail each of the components of the lamp 100 according to this embodiment, with reference to FIG. 1 to FIG. 3.

(Globe 10)

First, the globe 10 is described. As shown in FIG. 1 to FIG. 3, the globe 10 is a hollow housing for housing the LED module 20, and includes a translucent component which transmits light emitted by the LED module 20 to outside of the lamp 100.

In this embodiment, the globe 10 is configured of transparent glass (clear glass) made of silica glass which has thermal conductivity of 1.0 [W/m·K]. Thus, the LED module 20 housed in the globe 10 is visible from outside of the globe 10. As described above, having the transparent globe 10, it is possible to suppress loss of light from the LED module 20 due to the globe 10. Using glass for the globe 10 makes the globe 10 highly resistant to heat. Note that, the globe 10 is not limited to the globe made of silica glass, but may be made of resin, such as acrylic. Furthermore, the globe 10 may not be transparent, and diffusion treatment, such as forming a diffusion film on an inner surface of the globe 10, may be performed.

Before the globe 10 is sealed, the globe 10 has an opening 11 (narrow-diameter-part) forming a substantially circular opening plane. As a whole, the globe 10 has a sphere-like shape, which protrudes from the opening 11. In other words, the shape of the globe 10 is such that a part of the hollow sphere is narrowed down while extending away from the center of the sphere. The globe 10 has an opening 11 at a position away from the center of the sphere. The opening 11 is sealed after a predetermined gas is enclosed in the globe 10. With this, the globe 10 becomes a sealed space.

In this embodiment, the predetermined gas enclosed in the globe 10 is helium (He) having a thermal conductivity of 0.1513 [W/m·K]. The helium (a helium gas) enclosed in the globe 10 exists in the globe 10 so that the helium surrounds the LED module 20. The helium inside the globe 10 accounts for at least 50% of the entire gas which exists in the globe 10.

In this embodiment, the shape of the globe 10 is Type A (JIS C7710) used for the conventional incandescent light bulbs. Note that the shape of the globe 10 is not limited to Type A, but may be Type G, Type E, or the like.

(LED module 20)

The LED module 20 is a light-emitting module, and is housed in the globe 10. It is preferable that the LED module 20 be positioned at the center of the spherical shape formed by the globe 10 (for example, inside a large-diameter-part at which the inner diameter of the globe 10 is large). With the LED module 20 positioned at the center of the globe 10, the lamp 100 can achieve the light distribution property approximated to the light distribution property of an incandescent light bulb using a conventional filament coil, when the lamp 100 is switched on.

In addition, the LED module 20 is held in midair in the globe 10 (in the large-diameter-part of the globe 10 in this embodiment) by the two lead wires 50. In other words, the LED module 20 is held in the globe 10, away from the inner surface of the globe 10. With this, in the entire periphery of the LED module 20, the gas enclosed in the globe 10 exists. In other words, the LED module 20 is surrounded by the enclosed gas.

Power supply terminals are provided at the both ends of the LED module 20, and the power supply terminals and the lead wires are electrically connected by solder or others. The LED module 20 emits light using the power supplied from the two lead wires 50.

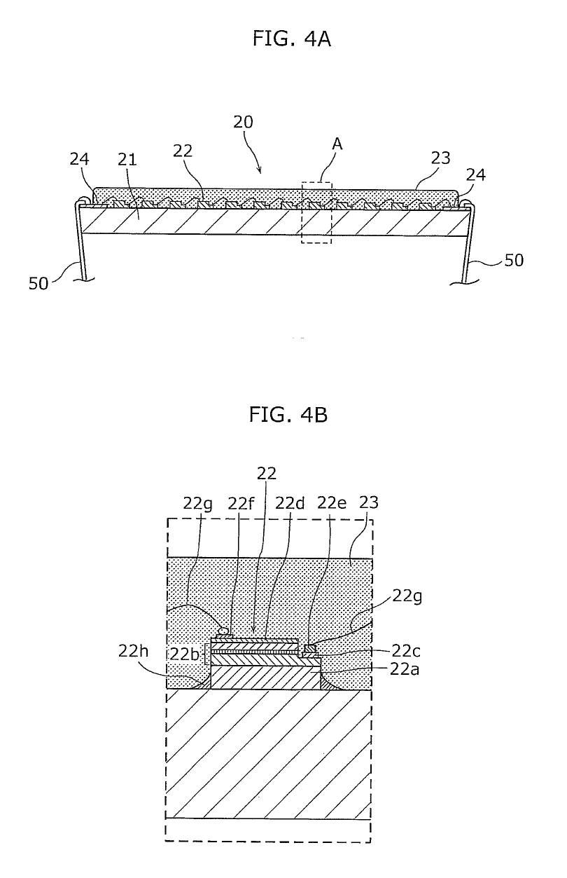

The following describes components of the LED module 20 according to this embodiment in detail, with reference to FIG. 4A and FIG. 4B. FIG. 4A is a cross-sectional view of the LED module 20 in the lamp 100 according to Embodiment 1 of the present invention. FIG. 4B is a partial enlarged cross-sectional view of the LED module 20 (region A enclosed by the broken line in FIG. 4A).

As shown in FIG. 4A, the LED module 20 according to this embodiment is a chip-on-board (COB) LED module configured of LED chips (bare chips) directly mounted on the base board, and includes a base board 21, a plurality of LEDs 22, and a sealing member 23. The LED module 20 is disposed so that the surface on which the LEDs 22 are mounted faces the top of the globe 10. The following describes components of the LED module 20 in detail.

First, the base board 21 is described. In this embodiment, the base board 21 is an LED mounting board for mounting the LEDs 22. The base board 21 includes: a surface (front surface) on which the LEDs 22 are mounted; and other surface (rear surface) opposite the former surface.

Furthermore, in this embodiment, the base board 21 is composed of a material translucent to the visible light. It is preferable that the base board 21 be a component having high total transmittance. With this, the light from the LEDs 22 transmits through the base board 21. Thus, the light is also emitted from a portion on which the LEDs 22 are not mounted. Thus, even when the LEDs 22 are mounted only on the front surface of the base board 21, the light is also emitted from the rear surface, enabling the light to be emitted omnidirectionally.

Note that, it is preferable that the total transmittance of the base board 21 to the visible light be higher than or equal to 80% or, more preferably, higher than or equal to 90% such that the other side can be seen through. The total transmittance of the base board 21 may be adjusted by the material composing the base board 21 or by changing the thickness of the base board 21 while using the same material. For example, it is possible to increase the total transmittance of the base board 21 by reducing the thickness of the base board 21.

Furthremore, the base board 21 may be made of inorganic material or resin material. For example, as the base board 21, a translucent ceramic board composed of alumina or aluminum nitride, a transparent glass board, a board composed of quartz or sapphire or, other than these, a flexible resin board, or the like may be used.

In addition, it is preferable that the base board 21 be composed of a member having high thermal conductivity and high thermal emissivity for increasing heat dissipation. In this case, it is preferable that the base board 21 be a glass board or a ceramic board. Here, the emissivity is represented by a ratio with respect to heat emission on black body (full radiator), and has a value between 0 and 1. The emissivity of glass or ceramic is 0.75 to 0.95, and thermal radiation close to the black body radiation is achieved. In terms of practical use, the emissivity of the base board 21 is preferably 0.8 or higher, and is more preferably 0.9 or higher.

Note that, in this embodiment, a rectangular alumina board having the total transmittance of 96% is used. Furthermore, although the base board 21 in this embodiment is translucent, the base board 21 need not necessarily be translucent. In other words, the configuration in which the light is emitted only from the front surface on which the LEDs 22 of the LED module 20 are mounted is acceptable. Furthermore, the LEDs 22 may be mounted on a plurality of surfaces of the base board 21.

Next, the LED 22 is described. The LED 22 is an example of a semiconductor light-emitting device, and is a bare chip which emits visible light in one color. As shown in FIG. 4A, the LEDs 22 are mounted on one side of the base board 21. In this embodiment, a plurality of LEDs 22 is arranged. Twelve LEDs 22 are arranged as one row, and four rows of the LEDs 22 are arranged in straight lines. In this embodiment, a blue LED chip which emits blue light when current flows is used for each of the LEDs 22. As a blue LED chip, a gallium nitride semiconductor light-emitting device which is made of InGaN series material and has a central wavelength from 440 nm to 470 nm can be used as the blue LED chip.

As shown in FIG. 4B, the LED 22 according to this embodiment is vertically long (600 μm long, 300 μm wide, and 100 μm thick). The LED 22 includes: a sapphire board 22a; and nitride semiconductor layers 22b each having different composition, which are stacked above the sapphire board 22a.

The cathode electrode 22c and the anode electrode 22d in the LEDs 22 next to each other are electrically connected in series by a gold wire 22g through the wire bonding portions 22e and 22f. The cathode electrode 22c or the anode electrode 22d in the LEDs 22 at the ends is connected to a corresponding one of the power supply terminals 24 (shown in FIG. 4A) by the gold wire 22g.

Each of the LEDs 22 is mounted on the base board 21 by translucent chip bonding material 22h such that a surface of the LED 22 on the sapphire board 22a side faces the mounting surface of the base board 21. Silicone resin including filler made of metal oxide may be used as the chip bonding material, for example. Using the translucent material for the chip bonding material 22h can reduce the loss of light emitted from the surface of the LED 22 on the side of the sapphire board 22a and the side surfaces of the LED 22, preventing the shadow of the chip bonding material.

Each of the LED 22 having the above configuration is configured to emit light omnidirectionally with the LED 22 as the center. In this embodiment, the LED 22 is an LED chip which emits light omnidirectionally, that is, upward, sideways, and downward of the LED 22. For example, the LED 22 is configured so that, among a total amount of emitted light, 60% of the light is emitted upward, 20% of the light is emitted sideways, and 20% of the light is emitted downward.

Note that, this embodiment describes the example in which LEDs 22 are arranged on the base board 21. The number of the LEDs 22 may be appropriately changed according to the use of the lamp.

Next, the sealing member 23 is described. The sealing member 23 is formed in a straight line (stripe) covering the LEDs 22. In this embodiment, four sealing members 23 are formed. Furthermore, the sealing member 23 includes a phosphor which is a material for converting wavelength of light, and also serves as a wavelength conversion layer which converts the wavelength of light emitted from the LED 22. A phosphor-containing resin obtained by dispersing, in a silicone resin, predetermined phosphor particles (not shown) and light diffusion material (not shown) may be used as the sealing member 23.

When the LED 22 is the blue LED which emits blue light, yellow phosphor particles of yttrium, aluminum, and garnet (YAG) series may be used as phosphor particles to provide white light. With this, part of blue light emitted from the LED 22 is converted to yellow light by wavelength conversion of the yellow phosphor particles included in the sealing member 23. The blue light that is not absorbed by the yellow phosphor particles and the yellow light obtained by the wavelength conversion by the yellow phosphor particles are dispersed and mixed in the sealing member 23, and thus are emitted from the sealing member 23 as white light.

Particles such as silica are used as the light diffusion material. In this embodiment, the translucent base board 21 is used. Accordingly, the white light emitted from the sealing member 23 transmits through the base board 21, and is also emitted from the rear surface and the like of the base board 21 on which no LED 22 is mounted.

The sealing member 23 with the configuration described above is formed, for example, as follows. First, an uncured paste including the wavelength conversion material (phosphor particles), which is material for the sealing member 23, is applied by a dispenser so as to cover the LEDs 22. Next, the applied paste of the material of the sealing member 23 is cured. With this, the sealing member 23 is formed.

Next, the power supply terminals 24 are described. The power supply terminals 24 are formed at the end portions of a diagonal of the base board 21. Each of the two lead wires 50 has a tip portion which is bent to form an L-shape to be electrically and physically connected to a corresponding one of the power supply terminals 24 by solder.

Note that, although not shown, a metal line pattern is formed on the LED mounting surface of the base board 21, and each of the LEDs 22 is electrically connected to the metal line pattern through wire or others. Power is supplied to each LED 22 through the metal line pattern. Note that, the line pattern may also be formed of translucent conductive material, such as indium tin oxide (ITO).

(Base 30)

Next, the base 30 is described. As shown in FIG. 1 to FIG. 3, the base 30 is a power receiving unit for receiving power for causing the LEDs 22 in the LED module 20 to emit light. In this embodiment, the base 30 receives alternating current (AC) voltage from an AC power source external to the lamp (for example a commercial power source of AC 200 V) with two contact points. Specifically, the side surface of the base 30 is a screw 31, and the bottom portion of the base 30 is an eyelet 32. The power received by the base 30 is input to the power input unit of the lighting circuit 60 through the lead wire.

The base 30 is provided at the opening 11 of the globe 10. More specifically, the base 30 is attached to the globe 10 using an adhesive, such as cement, to cover the opening 11 of the globe 10.

The base 30 is a metal tube with a bottom. A screw part for screwing in a socket of the lighting apparatus (lighting appliance) is formed on the outer circumferential surface of the base 30. In this embodiment, the base 30 is a type E26 base. Accordingly, the lamp 100 is used attached to a socket which is for the E26 base and connected to a commercial AC power source.

Note that, the base 30 need not necessarily be a type E26 base, but may also be a type E17 base or others. The base 30 need not necessarily be a screw-in base, but may also be a base of different shape, such as a plug-in base. Furthermore, although the above-described base 30 that can be directly attached to the opening 11 of the globe 10, the configuration of the globe 30 is not limited to the above. The base 30 may be indirectly attached to the globe 10. For example, the base 30 may be attached to the globe 10 via a resin component, such as a resin case. For example, the resin case may house the lighting circuit 60 or the like.

(Stem 40)

Next, the stem 40 is described. As shown in FIG. 1 to FIG. 3, the stem 40 is provided extending from the opening 11 of the globe 10 toward the inside of the globe 10. The stem 40 according to this embodiment is equivalent to a stem made of glass used for a common incandescent light bulb, and extending toward the inside of the globe 10.

As shown in FIG. 2, the end portion of the stem 40 on the base side is formed in a flared shape coinciding with the shape of the opening of the globe 10. The end portion of the stem 40 formed in the flared shape is joined with the opening 11 of the globe 10 so as to close the opening of the globe 10. Specifically, an end portion of the stem 40 and the opening of the globe 10 are joined by welding with heat. In addition, parts of two lead wires 50 are partially sealed in the stem 40. As described, the end portion of the stem 40 and the opening of the globe 10 are joined. With this, airtightness inside the globe 10 is maintained, and the globe 10 is thus in a sealed state. This prevents the helium enclosed in the globe 10 from leaking outside the lamp 100. Furthermore, since the inside of the globe 10 is kept airtight, the lamp 100 can prevent water, water vapor, or the like from entering the globe 10 for a long period of time, and it is possible to suppress the degradation of the LED module 20 due to moisture.

In this embodiment, the stem 40 is made of soft glass transparent to visible light. With this, it is possible to suppress the loss of light generated at the LED module 20, by the stem 40. In addition, formation of the shadow by the stem 40 can also be prevented.

(Lead wire 50)

Next, the lead wires 50 are described. As shown in FIG. 1 to FIG. 3, the two lead wires 50 are electric wires for holding and supplying power. More specifically, the lead wires 50 hold the LED module 20 at a constant position in the globe 10, and supply power supplied from the base 30 to the LEDs 22. The LED module 20 is held at a constant position in the globe 10 by the lead wires 50. Furthermore, the power supplied from the base 30 is supplied to the LEDs 22 of the LED module 20 through the two lead wires 50.

One of the ends of each of the lead wires 50 is connected to the corresponding one of the power supply terminals 24 of the LED module 20 by solder, and thus electrically connected to the power supply terminal 24. Furthermore, the other of the ends of each of the lead wires 50 is electrically connected to the power output unit of the lighting circuit 60.

Each of the lead wires 50 is, for example, a composite wire including an internal lead wire, a Dumet wire (copper-clad nickel steel wire), and an external lead wire joined in this order. Note that, the lead wire 50 need not necessarily be a composite wire, and may be a single wire made of the same metal wire. Furthermore, it is preferable that the lead wire 50 be a metal wire including copper having high thermal conductivity. With this, it is possible to conduct heat generated by the LED module 20 to the stem 40 through the lead wire 50 and dissipate the heat.

Note that, it is preferable that the lead wire 50 be attached to the base board 21 biasing the base board 21 toward the stem 40. With this, the base board 21 can be fixed and held to the stem 40 more firmly.

(Lighting circuit 60)

Next, the lighting circuit 60 is described. As shown in FIG. 2 and FIG. 3, the lighting circuit 60 is a circuit for lighting the LEDs 22, and is housed in the base 30. Specifically, the lighting circuit 60 includes a plurality of circuit elements and a circuit board onto which the circuit elements are mounted. In this embodiment, the lighting circuit 60 converts the AC power received from the base 30 into direct current (DC) power, and supplies the DC power to the LEDs 22 through the two lead wires 50.

The lighting circuit 60 includes, for example, a diode bridge for rectification, a capacitor for smoothing, and a resistor for adjusting current. One of the input terminals of the lighting circuit 60 is connected to the screw 31 of the base 30. The other of the input terminals of the lighting circuit 60 is connected to the eyelet 32 of the base 30.

Note that, although the lamp 100 in this embodiment includes the lighting circuit 60, the lamp 100 need not necessarily include the lighting circuit 60. For example, the lamp 100 need not include the lighting circuit 60, when the DC power is directly supplied from the lighting equipment, a battery cell, or others. Furthermore, in addition to a smoothing circuit, the lighting circuit 60 can include a light-adjusting circuit, a voltage boost circuit, or the like or a combination thereof.

(Functionality of the Present Invention)

As described above, the lamp 100 according to Embodiment 1 of the present invention includes, in the sealed lamp 100, helium. This configuration was conceived as a result of dedicated studies conducted by the inventers of the present application. The following describes the details.

As described above, LEDs have reduced light output as the temperature increases. Thus, in the conventional LED lamp, a heat sink is used for dissipating heat generated by the LED, and the LED module is fixed to the heat sink.

For example, in the conventional light bulb shaped LED lamp, a metal case which serves as the heat sink is provided between the semispherical globe and the base, and the LED module is fixed to the upper surface of the metal case. A heat sink is also used in the straight-tube LED lamp in order to dissipating heat generated by the LED. In this case, an elongated metal pedestal made of aluminum or the like is used as the heat sink. The metal pedestal is bonded to the inner surface of the straight tube with adhesive, and the LED module is fixed to the upper surface of the metal pedestal.

However, with such conventional light bulb shaped LED lamp and straight-tube LED lamp, among the light emitted by the LED module, the light emitted toward the heat sink is blocked by the metal heat sink. Consequently, the conventional LED lamps have a different light spread pattern from the lamps with an omnidirectional light-distribution property, such as a conventional incandescent light bulb, a light bulb shaped fluorescent light, or a straight-tube fluorescent light. In other words, it is difficult for the conventional light bulb shaped LED lamp to achieve a light distribution property similar to a light distribution property of the incandescent light bulb or an existing light bulb shaped fluorescent lamp. Furthermore, it is also difficult for the conventional straight-tube LED lamp to achieve a light distribution property similar to the light distribution property of an existing straight-tube fluorescent light.

In view of the above, for example, a light bulb shaped LED lamp may conceivably adopt a same configuration as an incandescent light bulb. More specifically, a light bulb shaped LED lamp may conceivably be configured without using a heat sink and by replacing a filament coil of an incandescent light bulb with an LED module. In this case, light from the LED module is not blocked by the heat sink.

However, the inventors of the present invention found that the LED lamp adopting the same configuration as the incandescent light bulbs cannot sufficiently dissipate the heat generated by the LED.

In view of this, the inventers of the present application conducted dedicated studies and gained knowledge that the heat generated by the LED module (LED) can be efficiently dissipated without using a metal heat sink by enclosing helium in the sealed lamp.

Specifically, in the lamp 100 according to this embodiment, helium is enclosed in the globe 10. This allows the heat generated by the LED module 20 (LEDs 22) to be efficiently conducted and radiated to the gas which exists in the globe 10 and contains helium because the helium has, among gases, relatively high thermal conductivity. Furthermore, the globe 10 has thermal conductivity higher than the thermal conductivity of helium. Thus, via the gas containing helium, the heat generated by the LED module 20 (LEDs 22) is efficiently conducted to the globe 10 in contact with the gas, and dissipated to outside of the lamp 100 through the globe 10.

As described above, with the lamp 100 according to this embodiment, the heat generated by the LED module 20 (LEDs 22) can be efficiently dissipated. Thus, it is possible to reduce deterioration of LED 22 which leads to a shorter lifetime.

In addition, the lamp 100 according to this embodiment also produces the advantageous effects described below, because the base board 21 of the LED module 20 is translucent.

As described above, focusing on making the light bulb shaped LED lamp to have a configuration similar to the configuration of the incandescent light bulb, the light bulb shaped LED lamp having the filament coil of the incandescent light bulb replaced with the LED module is conceived.

However, the LED module used for the conventional LED lamp has a configuration in which light is extracted only from a side of a surface of the board on which the LED is mounted. Since light radiated toward the heat sink among light emitted by the LED module is blocked by the heat sink as described earlier, the LED module is configured so that light emitted by the LED module travels not toward the heat sink but toward a side opposite to the heat sink. As described above, the conventional LED module is configured so that light is emitted only from one side of the board.

Accordingly, the light distribution property similar to the light distribution property of the conventional incandescent light bulb is not achieved even when the LED module used for the conventional light bulb shaped LED lamp and the straight-tube LED lamp is disposed in a bulb of the incandescent light bulb.

In contrast, since the base board 21 of the LED module 20 in the lamp 100 according to this embodiment is translucent, the light emitted by the LED 22 transmits through the base board 21. With this, the LED module 20 can emit light not only from the front surface on which the LEDs 22 are mounted but also from the rear surface, and thus can emit light omnidirectionally.

Thus, with the lamp 100 according to this embodiment, the light generated by the LEDs 22 can be emitted from the LED module 20 omnidirectionally without being blocked by the metal case. As described, according to this embodiment, the heat generated by the LED module 20 (LEDs 22) can be efficiently dissipated by the gas containing helium, and it is also possible to achieve a light-distribution property similar to the light-distribution property of the conventional incandescent light bulb.

Note that, although helium is enclosed as the predetermined gas in the globe 10 according to this embodiment, the gas is not limited to such an example. It is preferable that the other predetermined gas enclosed in the globe 10 contain a gas having a molecular weight smaller than the average molecular weight of air. For example, hydrogen (H₂) or nitrogen (N₂) can be used. In other words, the heat generated by the LED module 20 can also be easily dissipated to outside of the lamp 100 via the globe 10 by enclosing hydrogen or nitrogen instead of helium in the globe 10. Furthermore, gas may contain hydrogen or nitrogen along with helium. Note that, a mixture gas containing (i) hydrogen or (ii) hydrogen and helium is enclosed in the globe 10 so as to account for at least 50% of the entire gas which exists in the globe 10. Furthermore, it is preferable that a mixture gas containing (i) nitrogen or (ii) nitrogen and helium be enclosed in the globe 10 so as to account for at least 50% of the gas which exists in the globe 10. In addition, it is preferable that a mixture gas containing nitrogen, helium, and hydrogen be enclosed in the globe 10 so as to account for at least 50% of the gas which exists in the globe 10.

### Embodiment 2

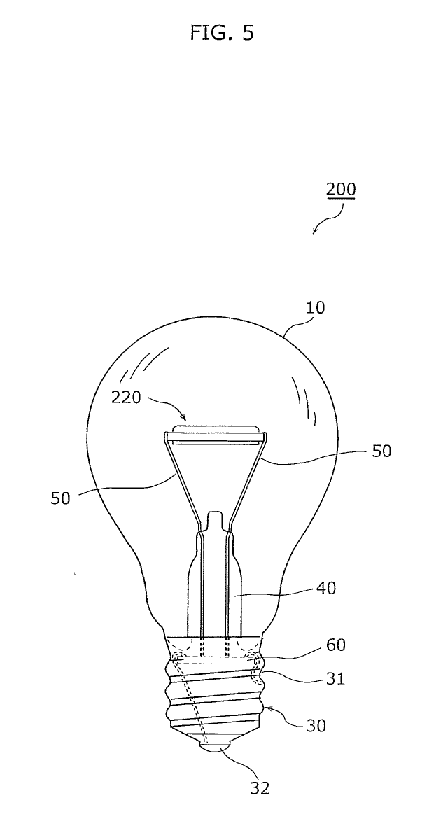

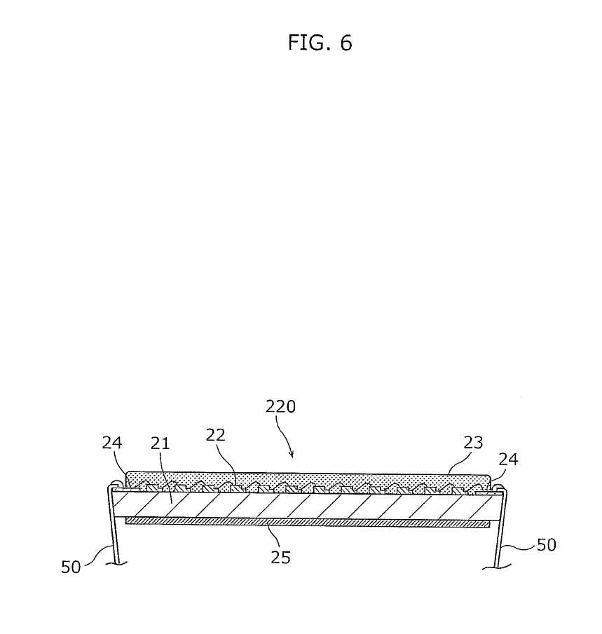

Next, a lamp 200 according to Embodiment 2 of the present invention is described with reference to FIG. 5 and FIG. 6. FIG. 5 is a front view of the lamp 200 according to Embodiment 2 of the present invention. FIG. 6 is a cross-sectional view of an LED module 220 in the lamp 200 according to Embodiment 2 of the present invention.

The basic configuration of the lamp 200 according to this embodiment of the present invention is identical to the configuration of the lamp 100 according to Embodiment 1 of the present invention. Accordingly, the components in FIG. 5 and FIG. 6 identical to the components shown in FIG. 1 to FIG. 4A are given the same reference numerals, and the detailed descriptions for these components are omitted.

The lamp 200 according to this embodiment is different from the lamp 100 according to Embodiment 1 in the configuration of the LED module. Compared to the LED module 20 according to Embodiment 1, the LED module 220 according to this embodiment further includes a wavelength conversion member on a rear surface of a base board 21 as shown in FIG. 5 and FIG. 6. The wavelength conversion member is for converting the wavelength of the light emitted by an LED 22 into a predetermined wavelength, and light with a wavelength identical to the wavelength of light generated by a sealing member 23 is generated in this embodiment. Note that, in this embodiment as well, helium is enclosed in a globe 10 so as to surround the LED module 220.

As shown in FIG. 6, the wavelength conversion member according to this embodiment is composed of a sintered material film 25 formed on the rear surface of the base board 21. The sintered material film 25 includes: a second wavelength conversion material for converting the wavelength of light transmitted through the translucent base board 21 among the light emitted by the LED 22 to a predetermined wavelength; and a binder for sintering made of an inorganic material.

Among the light emitted by the LED 22, the second wavelength conversion material in the sintered material film 25 converts the wavelength of light which entered the inside of the base board 21 from the front surface of the base board 21, transmitted through the base board 21, and emitted from the rear surface of the base board 21. Phosphor particles identical to the phosphor particles (first wavelength conversion material) contained in the sealing member 23 may be used as the second wavelength conversion material.

The binder for sintering of the sintered material film 25 includes a material which transmits the light emitted by the LED 22 and the wavelength converted light emitted by the second wavelength conversion material. In this embodiment, glass frit in which main component is silicon oxide (SiO₂) can be used as the binder for sintering. The glass frit is a binder (bonding material) for binding the second wavelength conversion material (phosphor particles) and the rear surface of the base board 21. It is preferable that the glass frit be made of material having a high transmittance to visible light. The glass frit can be formed by heating and melting the glass powder. As the glass powder for such a glass frit, SiO₂—B₂O₃—R₂O series, B₂O₃—R₂O series, or P₂O₅—R₂O series glass powder (note that, all of the R₂O is Li₂O, Na₂O, or K₂O) may be used. Alternatively, as the material for binder for sintering, SnO₂—B₂O₃, or the like made of low-melting point crystals may also be used other than the glass frit.

The sintered material film 25 configured as described above can be formed by printing or applying a paste obtained by kneading the phosphor particles, the glass powder, solvent, and others onto the rear surface of the base board 21 and subsequently performing sintering.

Note that, in the LED module 220 according to this embodiment as well, the emitted light is set to be white light, and a blue LED is used as the LED 22, in the same manner as Embodiment 1. Thus, as described above, YAG series yellow phosphor particles are used as the phosphor particles in the sealing member 23 and the phosphor particles in the sintered material film 25.

As described above, in the lamp 200 according to Embodiment 2 of the present invention, helium is enclosed in the globe 10. Thus, the heat generated by the LED module 20 (LEDs 22) can be dissipated to outside of the lamp 100 through the globe 10, as with Embodiment 1. With this, it is possible to reduce deterioration of the LED 22 which leads to the shorter lifetime.

In addition, in the lamp 200 according to this embodiment, the wavelength conversion member in the LED module 220 is composed of the sintered material film 25 made of an inorganic material. Accordingly, not only the wavelength conversion member is not deteriorated by the heat from the LEDs 22, it is also possible to efficiently dissipate the heat generated by the LEDs 22. With this, even when the wavelength conversion member is formed on the rear surface of the base board 21, the heat generated by the LED module 220 (LEDs 22) can be easily conducted to helium. Thus, it is possible to realize the lamp 200 which includes the LED module 220 having high reliability and a high heat-dissipation property.

Furthermore, according to the lamp 200 in this embodiment, the base board 21 is translucent. Thus, the light emitted by the LED 22 can be emitted from the LED module 220 omnidirectionally, in the same manner as Embodiment 1.

In this case, in this embodiment, part of blue light emitted from the LED 22 is converted to yellow light by wavelength conversion of the yellow phosphor particles included in the sealing member 23. Then, yellow light obtained by wavelength conversion by the yellow phosphor particles, and blue light of the LED 22 that is not absorbed by the yellow phosphor particles result in the emission of white light from the sealing member 23 (first wavelength conversion part). Furthermore, part of blue light emitted from the LED 22 is transmitted through the base board 21 and emitted from the rear surface of the base board 21, and converted to yellow light by wavelength conversion of the yellow phosphor particles included in the sintered-material film 25 formed on the rear surface of the base board 21. Then, yellow light obtained by wavelength conversion by the yellow phosphor particles, and blue light of the LED 22 that is transmitted through the base board 21 and not absorbed by the yellow phosphor particles result in the emission of white light from the sintered-material film 25 (second wavelength conversion part).

As described above, in this embodiment, the wavelength of blue light emitted by the LED 22 is converted not only by the sealing member 23 but also by the sintered material film 25. The white light is thus emitted. In this manner, this embodiment makes it possible to emit white light from both sides of the base board 21. Thus, the LED module 220 can emit white light omnidirectionally.

Note that, although the wavelength conversion member formed on the rear surface of the base board 21 is composed of the sintered material film 25 in this embodiment, the wavelength conversion member is not limited to such an example. For example, the wavelength conversion member can be formed by applying and curing the same material as the sealing member 23, namely, the phosphor-containing resin.

Furthermore, in the case in which the wavelength conversion member is composed of the sintered material film 25 as in this embodiment, it is preferable that the base board 21 be made of a highly heat-resistant material, such as ceramic or glass, since the sintered material film 25 is formed by sintering at a high temperature at approximately 600 degrees Celsius.

(Variation of Embodiment 2)

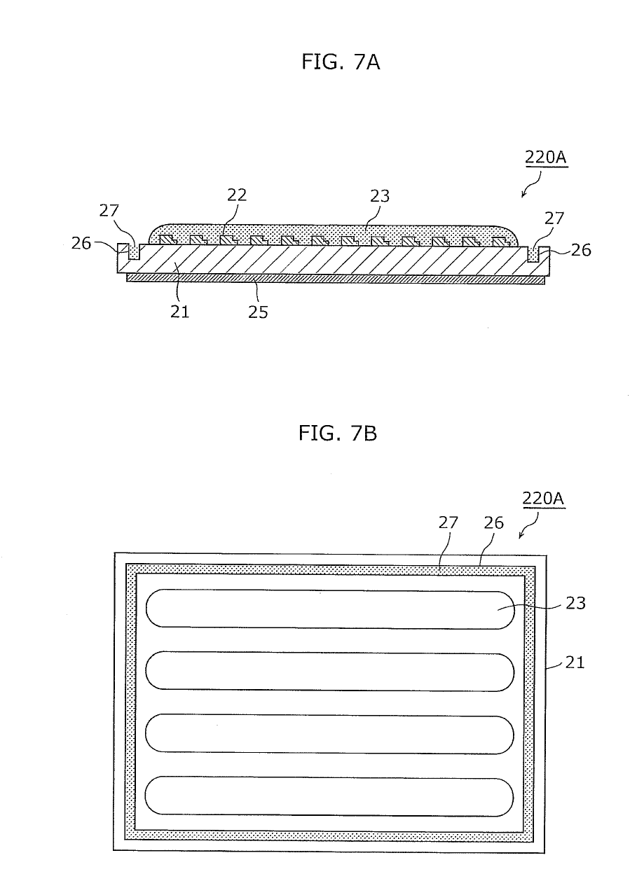

Next, the lamp according to a variation of Embodiment 2 of the present invention is described with reference to FIG. 7A and FIG. 7B. FIG. 7A is a cross-sectional view of an LED module 220A in a lamp according to the variation of Embodiment 2 of the present invention. FIG. 7B is a plan view of the LED module 220A.

The basic configuration of the lamp according to this variation is identical to the configuration of the lamp 200 according to Embodiment 2 of the present invention. Accordingly, description of the overall configuration of the lamp is omitted. In addition, the components in FIG. 7A and FIG. 7B identical to the components shown in FIG. 4A are given the same reference numerals, and the detailed descriptions for these components are omitted.

The lamp according to this variation is different from the lamp 200 according to Embodiment 2 in the configuration of the LED module. As shown in FIG. 7A and FIG. 7B, compared to the LED module 220 according to Embodiment 2, the LED module 220A according to this variation further includes a groove 26 formed on the front surface of the base board 21. Furthermore, a phosphor-containing resin 27 is filled in the groove 26.

As shown in FIG. 7A, the groove 26 is a recess formed on the front surface of the base board 21 toward its rear surface. Furthermore, as shown in FIG. 7B, the groove 26 is formed to be a rectangular loop to surround the sealing member 23, namely, the light emitting area. The groove 26 can be formed, for example, by cutting part of the front surface of the base board 21 using a laser or the like, before providing the LEDs 22 and the and sealing member 23.

The phosphor-containing resin 27 may include phosphor particles (third wavelength conversion material) which convert the wavelength of light emitted by the LED 22 to a predetermined wavelength. In this embodiment, the same phosphor-containing resin as the sealing member 23 is used as the phosphor-containing resin 27.

Note that, as with Embodiment 1, in the LED module 220A according to this embodiment as well, the emitted light is set to be white light, and a blue LED is used as the LED 22. Thus, as described above, YAG series yellow phosphor particles are used as the phosphor particles in the sealing member 23 and the phosphor particles in the sintered material film 25.

As described above, in the lamp according to the variation of Embodiment 2 of the present invention as well, helium is enclosed in the globe 10. Thus, the heat generated by the LED module 220A (LEDs 22) can be dissipated to outside of the lamp 100 through the globe 10, as with Embodiment 2. With this, it is possible to reduce the deterioration of LED 22 which leads to the shorter lifetime.

Furthermore, in this variation, the sintered-material film 25 is formed on the rear surface of the base board 21, as with Embodiment 2. This makes it possible to emit white light from both sides of the base board 21, and thus the LED module 220A can emit white light omnidirectionally.

Furthermore, in this variation, the groove 26 is formed on the base board 21, and the phosphor-containing resin 27 is filled in the groove 26. With this, it is possible to convert light which enters the inside of the base board 21 and travels toward a side surface of the base board 21 among the light emitted by the LED 22 can be converted to yellow light by wavelength conversion by the yellow phosphor particles in the groove 26. As a result, it is possible to suppress only blue light by the LED 22 being emitted from the side surface of the base board 21.

In this manner, this variation allows the light emitted from all of the surfaces of the base board 21 to be the predetermined white light, and the white light is emitted from the LED module 220A omnidirectionally.

Note that, although the groove 26 is formed only on the front surface of the base board 21 in this variation, the groove 26 may be formed on the rear surface or both surfaces of the base board 21.

### Embodiment 3

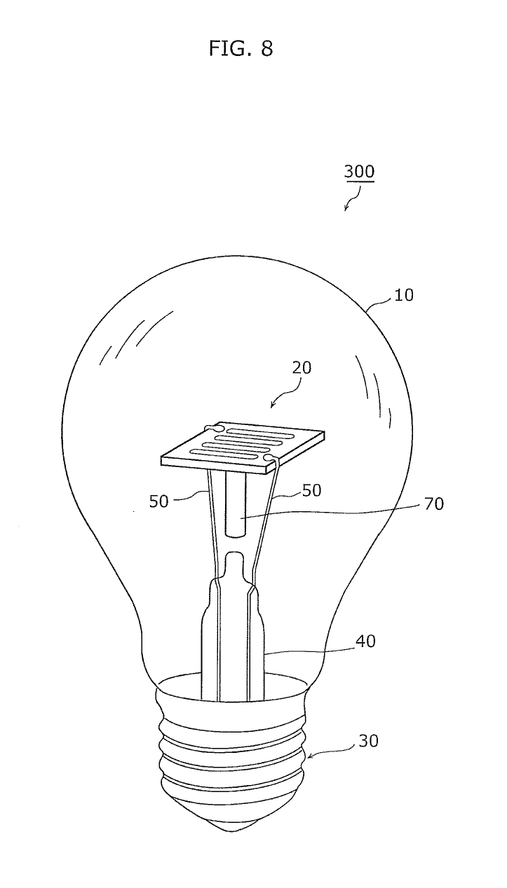

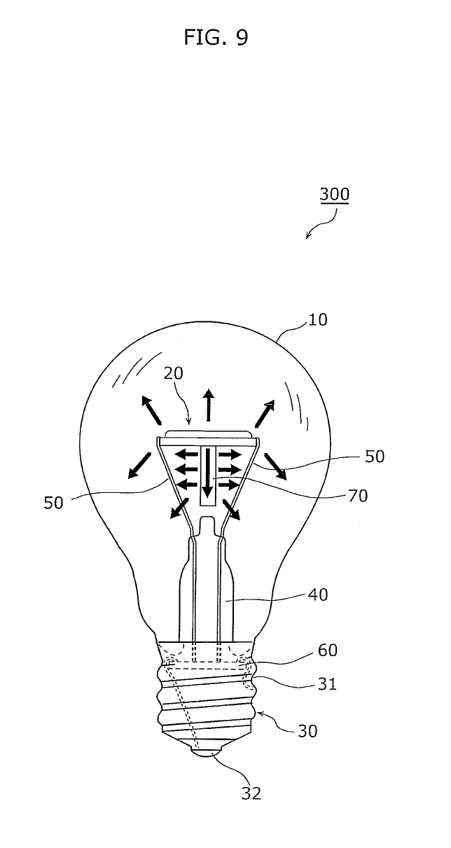

Next, a lamp 300 according to Embodiment 3 of the present invention is described with reference to FIG. 8 and FIG. 9. FIG. 8 is an external perspective view of the lamp 300 according to Embodiment 3 of the present invention. FIG. 9 is a front view of the lamp 300 according to Embodiment 3 of the present invention.

The basic configuration of the lamp 300 according to this embodiment is identical to the configuration of the lamp 100 according to Embodiment 1 of the present invention. Accordingly, the components in FIG. 8 and FIG. 9 identical to the components shown in FIG. 1 to FIG. 3 are given the same reference numerals, and the detailed descriptions for these components are omitted.

Compared to the lamp 100 according to Embodiment 1, the lamp 300 according to this embodiment is different in that the lamp 300 according to this embodiment further includes a heat sink 70. Note that, in this embodiment as well, helium is enclosed in a globe 10 so as to surround an LED module 20.

As shown in FIG. 8 and FIG. 9, in the lamp 300 according to this embodiment, the heat sink 70 is fixed to the rear surface of the base board 21 of the LED module 20. The heat sink 70 and the base board 21 can be bonded by adhesive or others.

The heat sink 70 in this variation is cylindrical, and is disposed so as to face a stem 40, extend toward the stem 40, and stand on the rear surface of the base board 21. In other words, the heat sink 70 extends toward the base 30. In this embodiment, the heat sink 70 is a cylinder of 5 [mm] in diameter and 40 [mm] in height.

It is preferable that the heat sink 70 be composed of material having thermal conductivity higher than the thermal conductivity of the base board 21 in the LED module 20. For example, the heat sink 70 may be composed of inorganic material, such as a metal material or ceramic. In this embodiment, the heat sink 70 is composed of aluminum having thermal conductivity of 237 [W/m·K].

As described above, in the lamp 300 according to Embodiment 3 according to the present invention, the heat sink 70 is fixed to the LED module 20. Thus, as shown in FIG. 8, the heat generated by the LED module 20 is conducted to the heat sink 70. With this, as with Embodiment 1, the heat generated by the LED module 20 is (i) conducted to the gas which contains helium and exists in the periphery of the LED module 20, and (ii) conducted and radiated to the gas containing the helium through the heat sink 70 as well. As a result, the heat generated by the LED module 20 (LEDs 22) can be more efficiently dissipated to outside of the lamp 300 through the globe 10 than Embodiment 1. Thus, it is possible to reduce the deterioration of LED 22 which leads to the shorter lifetime.

Furthermore, in this embodiment, the heat sink 70 is fixed to the rear surface of the base board 21. With this, it is possible to reduce the effect on the traveling of the light emitted from the front surface of the board 21 caused by the heat sink 70. This makes it possible to reduce deterioration of the light distribution property of the lamp 300 caused by the heat sink 70.

Furthermore, in this embodiment, the heat sink 70 extends toward the base 30. With this, the heat sink 70 can be disposed close to the stem 40. Thus, the heat conducted to the heat sink 70 can be conducted to the stem 40. Therefore, the heat inside the lamp 300 can also be efficiently dissipated through the base 30 made of a metal. Note that, the heat sink 70 and the stem 40 may be in contact with each other. With this, the heat dissipation effect can be further improved. Furthermore, the heat sink 70 extending to the vicinity of the base 30 enables the heat of the heat sink 70 to be conducted to the base 30 efficiently. Thus, the heat dissipation effect can be further improved.

Furthermore, in this embodiment, it is preferable that the heat sink 70 include material having thermal conductivity higher than the thermal conductivity of the base board 21 of the LED module 20. With this, the heat of the LED module 20 can be efficiently conducted to the heat sink 70 through the base board 21. Thus, the heat inside the lamp 300 can be dissipated to outside of the lamp more efficiently.

Furthermore, in this embodiment, the base board 21 in the LED module 20 may be composed of a ceramic material or the like having low total transmittance or a non-translucent material, such as a metal, emphasizing on the heat dissipation capability. With this, the heat generated by the LED module 20 can be dissipated more efficiently. Thus, even when the high-output LED module 20 is used, it is possible to reduce the deterioration of the LED 22. Note that, when the base board 21 includes ceramic material, the thermal conductivity of the base board 21 can be increased by reducing the diameter of the ceramic particles included in the base board 21. However, conversely, doing so decreases the transmissivity of the base board 21.

Furthermore, although the heat sink 70 in this embodiment includes non-translucent material of aluminum, the heat sink 70 is not limited to such an example. The heat sink 70 may be composed of translucent ceramic, translucent resin, or transparent resin. The translucent heat sink 70 as described above makes it possible to reduce the deterioration of the light distribution property of the lamp 300 caused by the heat sink 70. Particularly, when the LED module 20 is designed to emit light omnidirectionally, the lamp 300 can have the omnidirectional light distribution property similar to the omnidirectional light distribution property of the conventional incandescent light bulb.

Furthermore, although the heat sink 70 in this embodiment is provided on the rear surface of the base board 21, the heat sink 70 is not limited to such an example. Furthermore, although only one heat sink 70 is provided, the number of the heat sinks 70 is not limited to such an example. A plurality of the heat sinks 70 may be provided.

Note that, to obtain in this embodiment a lamp having omnidirectional light distribution property similar to the omnidirectional light distribution property of the conventional incandescent light bulb, the LED module 220, and 220A respectively according to Embodiment 2 and its variation can be applied to this embodiment. In this case, it is preferable that the material of the heat sink 70 be a translucent material or a transparent material.

(Variation 1 of Embodiment 3)

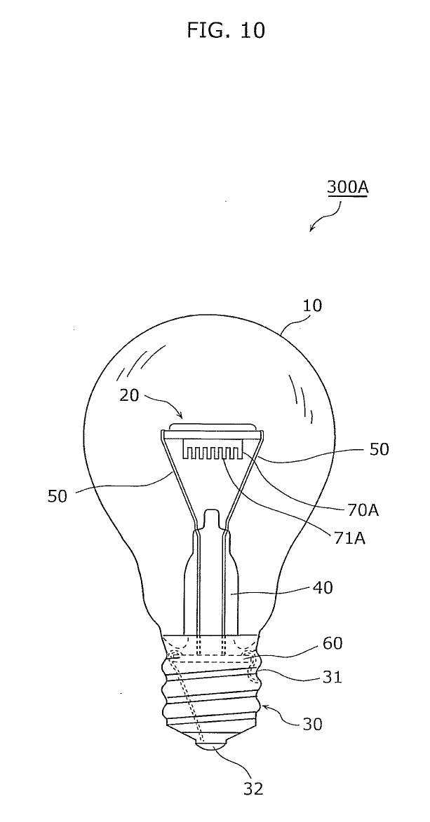

Next, a lamp 300A according to Variation 1 of Embodiment 3 of the present invention is described with reference to FIG. 10. FIG. 10 is a front view of the lamp 300A according to Variation 1 of Embodiment 3 of the present invention.

The basic configuration of the lamp 300A according to this variation is identical to the configuration of the lamp 300 according to Embodiment 3 of the present invention. Accordingly, the components in FIG. 10 identical to the components shown in FIG. 8 and FIG. 9 are given the same reference numerals, and the detailed descriptions for these components are omitted.

The lamp 300A according to this variation is different from the lamp 300 according to Embodiment 3 in the configuration of the heat sink.

As shown in FIG. 10, the heat sink 70A in the lamp 300A according to this variation includes a heat dissipation fin 71A. The heat dissipation fin 71A is formed so as to face the stem 40. Note that, as with Embodiment 3, it is preferable that the heat sink 70A be composed of material having thermal conductivity higher than the thermal conductivity of the base board of the LED module 20. In this embodiment, the heat sink 70A is composed of aluminum having thermal conductivity of 237 [W/m·K].

As described above, the lamp 300A according to this variation can produce similar advantageous effects as the lamp 300 according to Embodiment 3. Furthermore, in the lamp 300A according to this variation, the heat sink 70A includes the heat dissipation fin 71A. This makes it possible to increase the contact area of the heat sink 70A and the gas inside the globe 10. With this, the heat generated by the LED module 20 (LEDs 22) can be efficiently conducted to the gas inside the globe 10. Thus, the heat generated by the LED module 20 (LEDs 22) can be more efficiently dissipated to outside of the lamp 300A through the globe 10 than Embodiment 3. Thus, it is possible to further reduce the deterioration of LED 22 which leads to the shorter lifetime.

(Variation 2 of Embodiment 3)

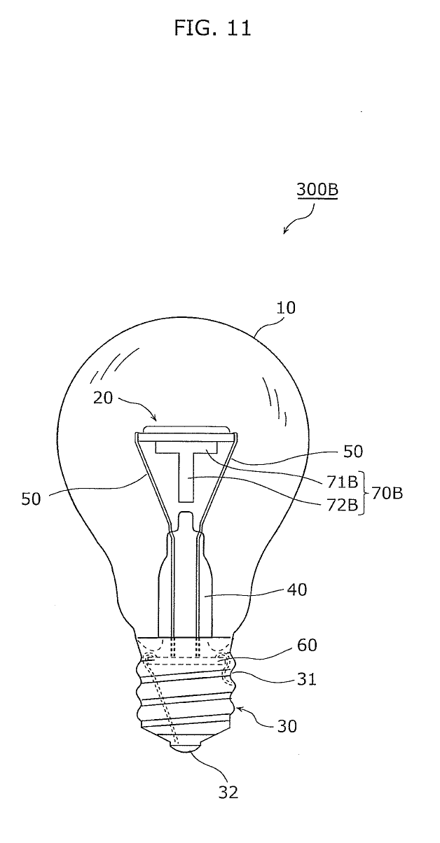

Next, a lamp 300B according to Variation 2 of Embodiment 3 of the present invention is described with reference to FIG. 11. FIG. 11 is a front view of the lamp 300B according to Variation 2 of Embodiment 3 of the present invention.

The basic configuration of the lamp 300B according to this variation is identical to the configuration of the lamp 300 according to Embodiment 3 of the present invention. Accordingly, the components in FIG. 11 identical to the components shown in FIG. 8 and FIG. 9 are given the same reference numerals, and the detailed descriptions for these components are omitted.

The lamp 300B according to this variation is different from the lamp 300 according to Embodiment 3 in the configuration of the heat sink.

As shown in FIG. 11, a heat sink 70B in the lamp 300B according to this variation is formed so as to be in a T-shape when seen from the front. Specifically, the heat sink 70B in this variation includes a wide-width part 71B on the side of the LED module 20; and a rod-shaped portion 72B on the side of the stem. The rod-shaped portion 72B is provided at the center of the wide-width part 71B. The wide-width part 71B is fixed to the rear surface of the base board of the LED module 20, and the heat sink 70B is thus fixed to the LED module 20. As with the heat sink 70 in Embodiment 3, the rod-shaped portion 72B is provided so as to extend toward the stem 40.

Note that, in this variation, the wide-width part 71B and the rod-shaped portion 72B are integrally formed. Note that, as with Embodiment 3, it is preferable that the heat sink 70B include material having thermal conductivity higher than the thermal conductivity of the base board 21 of the LED module 20. In this embodiment, the heat sink 70B includes aluminum having thermal conductivity of 237 [W/m·K].

As described above, the lamp 300B according to this variation can produce similar advantageous effects as the lamp 300 according to Embodiment 3. Furthermore, the lamp 300B according to this variation includes the wide-width part 71B. Thus, it is possible to increase the contact area of the heat sink 70B and the base board of the LED module 20. With this, the heat generated by the LED module 20 (LEDs 22) can be efficiently conducted to the heat sink 70B. Thus, the heat generated by the LED module 20 (LEDs 22) can be more efficiently dissipated to outside of the lamp 300B through the globe 10 than Embodiment 3. Thus, it is possible to further reduce the deterioration of LED 22 which leads to the shorter lifetime.

(Variation 3 of Embodiment 3)

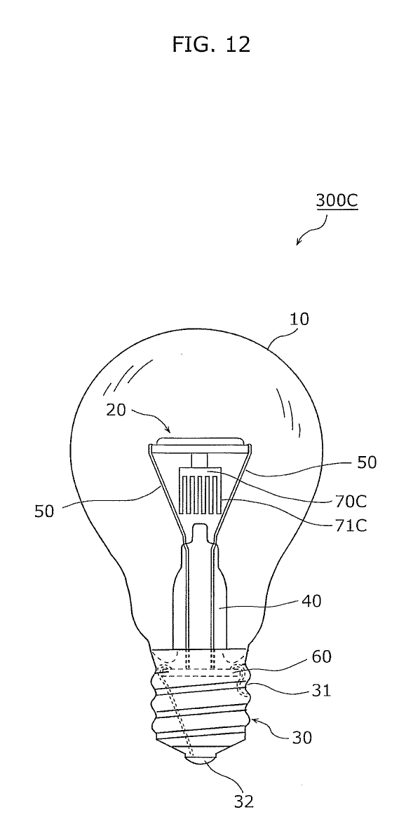

Next, a lamp 300C according to Variation 3 of Embodiment 3 of the present invention is described with reference to FIG. 12. FIG. 12 is a front view of the lamp 300C according to Variation 3 of Embodiment 3 of the present invention.

The basic configuration of the lamp 300C according to this variation is identical to the configuration of the lamp 300 according to Embodiment 3 of the present invention. Accordingly, the components in FIG. 12 identical to the components shown in FIG. 8 and FIG. 9 are given the same reference numerals, and the detailed descriptions for these components are omitted.

The lamp 300C according to this variation is different from the lamp 300 according to Embodiment 3 in the configuration of the heat sink.

As shown in FIG. 12, a heat sink 70C in the lamp 300C according to this variation includes a heat sink portion 71C. One end of the heat sink 70C is in an octopus-leg like shape. The heat sink portion 71C of the heat sink 70C is formed so as to face the stem 40. Note that, as with Embodiment 3, it is preferable that the heat sink 70C be composed of material having thermal conductivity higher than the thermal conductivity of the base board of the LED module 20. In this embodiment, the heat sink 70C is composed of aluminum having thermal conductivity of 237 [W/m·K].

As described above, the lamp 300C according to this variation can produce similar advantageous effects as the lamp 300 according to Embodiment 3. Furthermore, in the lamp 300C according to this variation, the heat sink portion 71C in the octopus-leg like shape is provided below the heat sink 70C. This makes it possible to increase the contact area of the heat sink 70C and the gas inside the globe 10. With this, the heat generated by the LED module 20 (LEDs 22) can be efficiently conducted to the gas inside the globe 10. Thus, the heat generated by the LED module 20 (LEDs 22) can be more efficiently dissipated to outside of the lamp 300C through the globe 10 than Embodiment 3. Thus, it is possible to further reduce the deterioration of LED 22 which leads to the shorter lifetime.

### Example

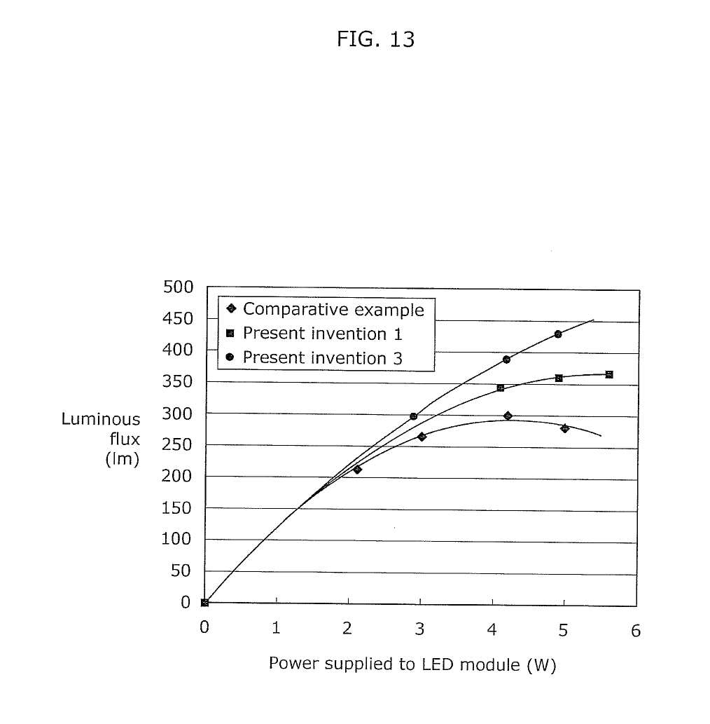

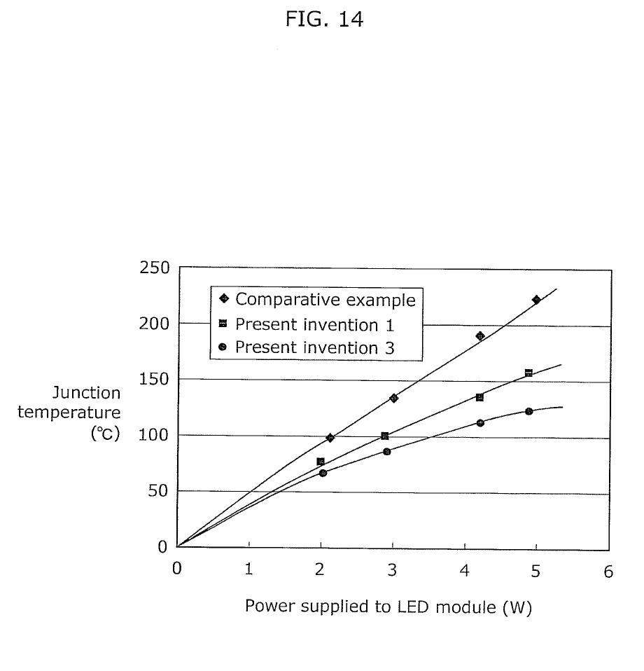

Next, experimental results on the lamps according to embodiments of the present invention are described with reference to FIG. 13 and FIG. 14. FIG. 13 and FIG. 14 are diagrams for describing the experimental results on lamp according to embodiments of the present invention. FIG. 13 is a diagram showing the relationship between the luminous flux and the power supplied to LED modules. FIG. 14 is a diagram showing the relationship between the junction temperatures of LEDs and the power supplied to LED modules. It should be noted that, in FIG. 13 and FIG. 14, the curve representing present invention 1 (squares) shows characteristics of the lamp 100 (including helium) according to Embodiment 1 of the present invention shown in FIG. 3, the curve representing present invention 3 (circles) shows characteristics of the lamp 300 (including helium and the heat sink) according to Embodiment 3 of the present invention shown in FIG. 9, and the curve representing the comparative example (diamonds) shows characteristics of a lamp (including air) which is obtained by enclosing air instead of helium in the lamp 100 according to Embodiment 1 of the present invention shown in FIG. 3. Note that, the power supplied in the experiment is, for example, in the case of the LED module according to this embodiment (including approximately 50 LED chips), approximately a little less than 5 W.

As shown in FIG. 13, compared to the comparative example 1 including air, the present invention 1 including helium has improved luminous flux for the same amount of supply power.

Furthermore, as shown in FIG. 13, compared to the present invention 1, the present invention 3 including helium and the heat sink has more improved luminous flux for the same amount of supply power. Furthermore, the present invention 3 does not exhibit the decrease in the luminous flux even when the supply power is increased, indicating that the heat is efficiently dissipated.

Furthermore, as shown in FIG. 14, the junction temperature of the LED is significantly improved with the present invention 1 as compared to the comparative example 1. In addition, the present invention 3 has more improved junction temperature of the LED than the present invention 1.

As described above, the lamps according to embodiments of the present invention make it possible to efficiently dissipate the heat generated by the LED module 20 (LEDs 22). Thus, it is possible to reduce the deterioration of LED which leads to the shorter lifetime.

(Lighting Apparatus)

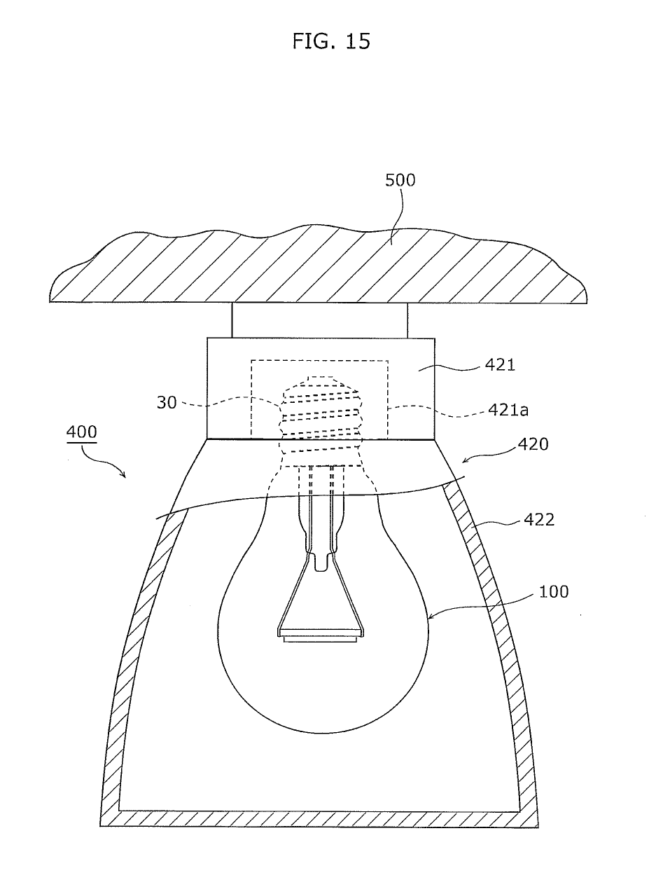

Next, a lighting apparatus 400 according to an embodiment of the present invention is described with reference to FIG. 15. FIG. 15 is a schematic cross-sectional view of the lighting apparatus 400 according to the embodiment in the present invention.

As shown in FIG. 15, the lighting apparatus 400 according to the embodiment in the present invention is used attached to a ceiling 500 in a room, and includes the lamp 100 according to Embodiment 1 of the present invention and lighting equipment 420.

The lighting equipment 420 is for turning the lamp 100 on and off, and includes an equipment body 421 attached to the ceiling 500 and a translucent lamp cover 422 covering the lamp 100.

The equipment body 421 includes a socket 421a. The base 30 of the lamp 100 is screwed into the socket 421a. Power is supplied to the lamp 100 through the socket 421a.

Note that, although the lighting apparatus 400 shown in FIG. 15 includes one lamp 100, the lighting apparatus 400 may include more than one lamp 100. In addition, the lighting apparatus according to an aspect of the present invention requires at least a socket for holding the lamp 100 and for supplying power to the lamp 100. Note that, the base 30 need not necessarily be screwed into the socket 421a, but may also be simply inserted. Furthermore, although this embodiment used the lamp 100 according to Embodiment 1 of the present invention, the lamps according to other embodiments and variations may also be used.

### Other Variations

Next, variations of the lamps according to embodiments of the above-described present invention are described. Note that, the lamps according to the variations can be applied to the lighting apparatus 400 according to the embodiment in the present invention.

(Variation 1)

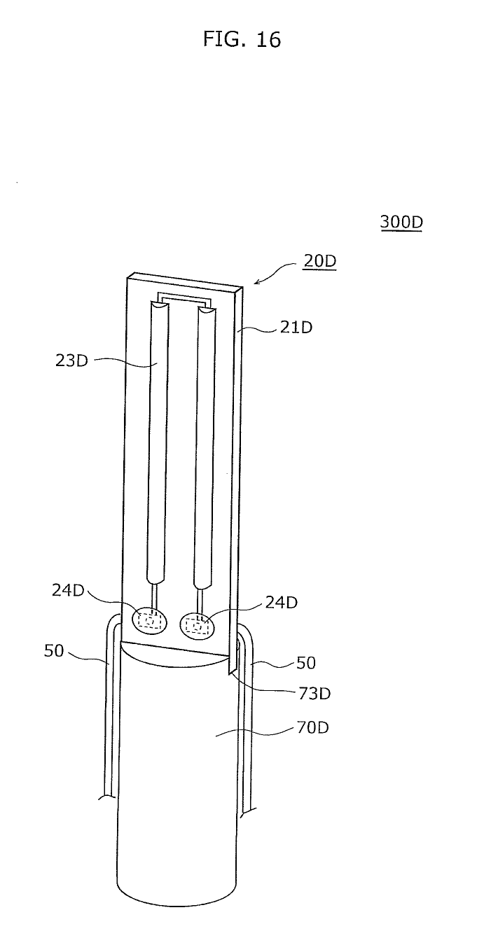

First, a lamp 300D according to Variation 1 of the present invention is described with reference to FIG. 16. FIG. 16 is an enlarged view of a major part of the lamp 300D according to Variation 1 of the present invention. Note that, the overall configuration of the lamp 300D according to this variation is similar to the overall configuration of the lamp 300 according to Embodiment 3 of the present invention, and thus the description of the overall configuration of the lamp is omitted.

An LED module 20D according to this variation has a similar configuration as the LED module 20 according to Embodiment 1, and includes an elongated translucent base board 21D, LEDs (not shown), a sealing member 23D for sealing the LEDs, and power supply terminals 24D. Each of the components in the LED module 20D has a similar function as the corresponding one of the components in the LED module 20.

Furthermore, although a heat sink 70D in this variation has a similar configuration as the heat sink 70 in Embodiment 3, the heat sink 70D in this variation includes a groove 73D formed on the fixing portion between the heat sink 70D and the LED module 20D.

The groove 73D is formed so as to have the width approximately the same as the thickness of the base board 21D in the LED module 20D. For example, the shape of the groove 73D may be a recess in cross-section, fitting edge portion of the base board 21D. With this, the edge portion of the base board 21D on the shorter side of the base board 21D is inserted into the groove 73D. The heat sink 70D and the LED module 20D can be thus fixed together. Note that, the heat sink 70D and the base board 21D can be fixed by adhesive applied around the groove 73D or by a screw.

In addition, the LED module 20D in this variation is disposed in the globe such that the base board 21D stands on the heat sink 70D. In other words, in the LED module 20D, the base board 21D is fixed to the heat sink 70D standing, and the LED module 20D is disposed in the globe so that the base board 21D is vertically disposed. With this configuration, the predetermined light emitted from the LED module 20D is mainly emitted in a direction toward the lateral periphery of the globe.

Furthermore, according to this variation, the base board 21D is inserted into the groove 73D of the heat sink 70D. The heat sink 70D and the LED module 20D are thus fixed together. With this, the position and orientation of the base board 21D can be regulated by the groove 73D.

Note that, although the groove 73D is formed on the heat sink 70D to fix the heat sink 70D to the LED module 20D, the method for fixing is not limited to such an example. For example, without providing the groove 73D according to Embodiment 3, the upper surface of the heat sink 70D and the edge portion of the shorter side of the base board 21D may be bonded and fixed by adhesive or others.

Furthermore, Embodiment 2 or the variation of Embodiment 2 may be applied to this variation. Specifically, a sintered-material film including a phosphor as a wavelength conversion member can be formed on the rear surface of the base board 21D. Alternatively, a groove in which a phosphor-containing resin is filled can be provided on the front surface of the base board 21D.

(Variation 2)

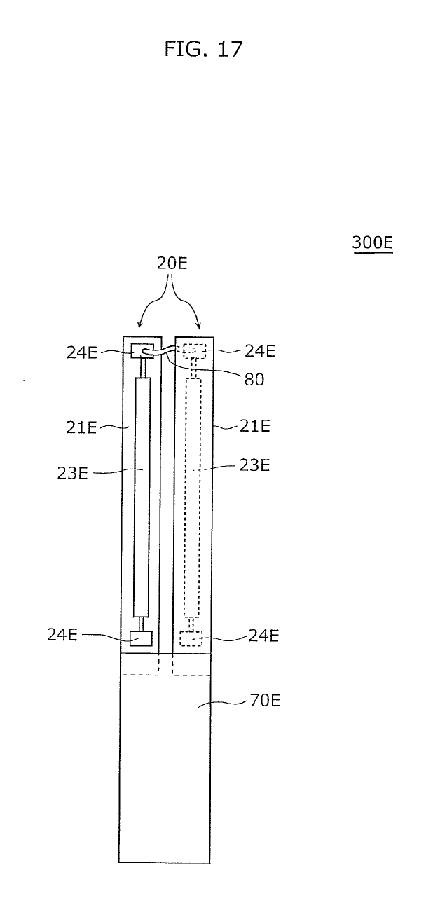

Next, a lamp 300E according to Variation 2 of the present invention is described with reference to FIG. 17. FIG. 17 is an enlarged view of a major part of the lamp 300E according to Variation 2 of the present invention. Note that, the overall configuration of the lamp 300E according to this variation is also similar to the overall configuration of the lamp 300 according to Embodiment 3 of the present invention, and thus the description of the overall configuration of the lamp is omitted.

The configuration of the lamp 300E according to this variation is basically identical to the configuration of the lamp 300D according to Variation 1. Accordingly, the LED module 20E in this variation basically has a configuration similar to the configuration of the LED module 20D according to Variation 1, and includes an elongated translucent base board 21E, LEDs (not shown), a sealing member 23E for sealing the LEDs, and power supply terminals 24E. Each of the components of the LED module 20E has a similar function as the corresponding one of the components of the LED module 20D.

Furthermore, the lamp 300E according to this variation is different from the lamp 300D according to Variation 1 in that, in the lamp 300E according to this variation, a plurality of LED modules 20E are fixed to a heat sink 70E. Specifically, as shown in FIG. 17, in the lamp 300E according to this variation, two LED modules 20E are used, namely, a plurality of base boards 21E is used. Note that, in each of the LED modules 20E, the width of the base board 21E is approximately half the width of the base board 21E according to Variation 1, and one row of the sealing member 23E is formed.

Furthermore, the LED modules 20E are electrically connected to each other by a lead wire 80 which connects the power supply terminals 24E of the LED modules 20E.

Note that, the heat sink 70E in this variation has a similar configuration as the heat sink 70D in Variation 1.

In addition, in this variation as well, the LED module 20E is disposed in the globe such that the base board 21E stands on the heat sink 70E. With this configuration, the predetermined light emitted form the LED module 20E is mainly emitted in a direction toward the lateral periphery of the globe.

In addition, in this variation, the two LED modules 20E are arranged so that the front surface (the surface on which the sealing member 23E is formed) of one of the two LED modules 20E is opposite to the front surface (the surface on which the sealing member 23E is formed) of the other of the LED modules 20E. In this manner, arranging two LED modules 20E so as to face opposite directions makes it possible to emit the predetermined light with the same light-distribution property to both lateral sides of the globe.

Note that, Embodiment 2 or the variation of Embodiment 2 may be applied to this variation. Specifically, a sintered-material film including a phosphor as a wavelength conversion member can be formed on the rear surface of the base board 21E. Alternatively, a groove in which a phosphor-containing resin is filled can be provided on the front surface of the base board 21E.

Furthermore, in this variation, the heat sink 70E and the base board 21E can be fixed together by adhesive or a screw, as with Variation 1. Furthermore, the base board 21E can be formed so as to have an L-shape, and the L-shaped base board 21E and the heat sink 70E can be fixed together.

(Variation 3)

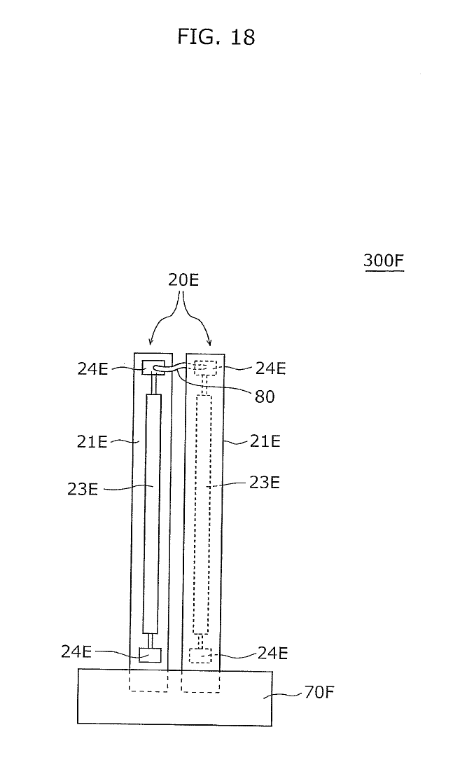

Next, a lamp 300F according to Variation 3 of the present invention is described with reference to FIG. 18. FIG. 18 is an enlarged view of a major part of the lamp 300F according to Variation 3 of the present invention. Note that, the overall configuration of the lamp 300F according to this variation is also similar to the overall configuration of the lamp 300 according to Embodiment 3 of the present invention, and thus the description of the overall configuration of the lamp is omitted.

The configuration of the lamp 300F according to this variation is basically identical to the lamp 300E according to Variation 2. Accordingly, the components in FIG. 18 identical to the components shown in FIG. 17 are given the same reference numerals, and the detailed descriptions for these components are omitted.

The lamp 300F according to this variation is different from the lamp 300E according to Variation 2 in the configuration of the heat sink. Specifically, a heat sink 70F in this variation is horizontally elongated. With this, the LED module 20E and the heat sink 70F are fixed together so as to form a reverse T-shape.

This variation also produces similar advantageous effects as the lamps according to Variation 1 and Variation 2. Note that, Embodiment 2 or the variation of Embodiment 2 may be applied to this variation as well. Furthermore, as with Variation 2, the heat sink 70F and the base board 21E can be fixed together by adhesive or a screw. It is also possible to form the base board 21E so as to have an L-shape, and the L-shaped base board 21E and the heat sink 70F can be fixed together.

(Variation 4)

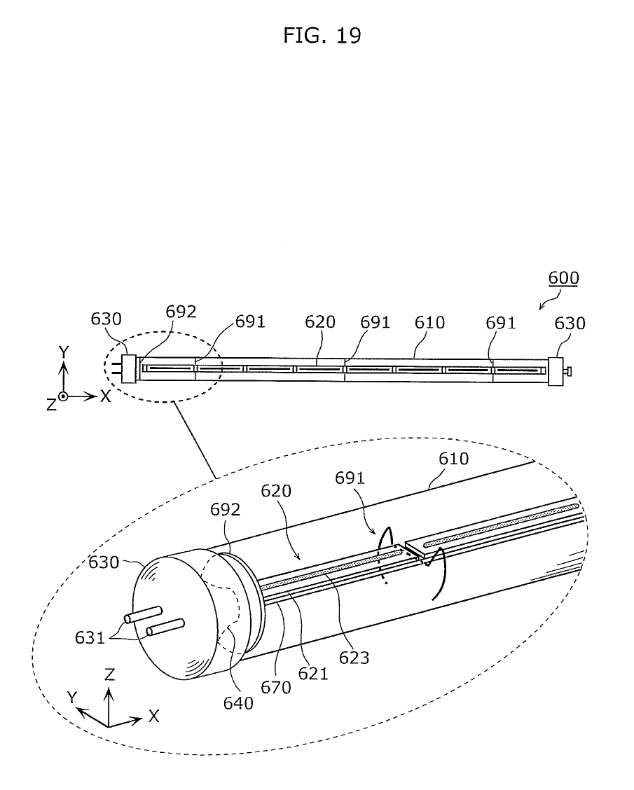

Next, a lamp 600 according to Variation 4 of the present invention is described with reference to FIG. 19. FIG. 19 shows a top view and a perspective view which schematically show a configuration of a lamp 600 according to Variation 4 of the present invention.

As shown in FIG. 19, the lamp 600 according to this variation is a straight-tube LED lamp, and includes: an elongated board 670 on which a plurality of LED modules 620 are arranged in a straight line; and an outer member 610 which includes a translucent straight tube glass. As with the other embodiments and variations, gas which contains at least one of helium, hydrogen, and nitrogen is enclosed in the outer member 610 so as to surround the LED modules 620. Each of the LED modules 620 in this variation is a light-emitting module having an elongated shape, and includes: a base board 621 having an elongated shape; a plurality of LEDs (not shown) mounted in line on the base board 621; and a seal sealing member 623 which seals the LEDs collectively.

The board 670 which supports the LED modules 620 is held at a predetermined position inside the outer member 610 by three holding members 691. Each of the holding members 691 includes an elastic line-like member made of metal. The line-like component is in contact with the inner surface of the outer member 610, thereby holding the board 670 in a predetermined position inside the outer member 610.

Furthermore, as with Embodiment 1, each of ends of the outer member 610 is joined to a corresponding one of the flare-shaped end portions of a stem 640 by heat welding. With this, inside of the outer member 610 is kept airtight, preventing gas, such as helium or the like, enclosed in the outer member 610 from leaking out. Note that, although not shown, two lead wires are partially sealed in the stem 640, as with Embodiment 1.

Note that, heat of approximately 700 degrees Celsius is emitted by a burner or the like for several tens of seconds in the direction of the LED module 620, when the stem 640 and the outer member 610 are welded by heat. Thus, a heat shield 692 made of ceramic or the like is provided to block such heat. Furthermore, at each ends of the sealed outer member 610, a base 630 including a pair of base pins 631 for receiving power is provided.

As described above, gas, such as helium, is enclosed in the outer member 610 in the lamp 600 according to this variation as well. Thus, as with Embodiment 1, the heat generated by the LED module 620 can be easily dissipated to outside the lamp 600.

Although the lamp according to an aspect of the present invention has been described based on the embodiments and variations, the present invention is not limited to such embodiments and variations.

For example, although the lamp in the above-described embodiment received power from a commercial AC power source, the lamp may, for example, receive DC power from a battery or the like. In this case, the lamp need not include the lighting circuit.

Furthermore, although an LED is exemplified as a semiconductor light emitting device in the embodiments described above, other semiconductor light emitting device, such as a semiconductor laser, an organic electro luminescence (EL), or an inorganic EL, is also acceptable.

Furthermore, although the above-described embodiments and variations described the light bulb shaped or straight-tube lamps, the lamp is not limited to such examples. For example, the present invention can also be applied to a circular-tube lamp or the like. Specifically, in the circular-tube lamp or the like, helium, hydrogen, or nitrogen can be enclosed in the sealed lamp housing (circular-tube). Furthermore, as with above-described embodiments, a heat sink may be provided in the LED module. Note that, in the circular-tube lamp or the like, a supporting member which supports an LED module is provided in the circular-tube.

In addition to the above, various modifications of the embodiments and variations as well as embodiments resulting from arbitrary combinations of components of different embodiments and variations that may be conceived by those skilled in the art are intended to be included within the scope of the present invention as long as these do not depart from the essence of the present invention.

### INDUSTRIAL APPLICABILITY

The present invention is useful as an LED lamp, a lighting apparatus, or the like replacing the lamp, such as a conventional incandescent light bulb.

### REFERENCE SIGNS LIST

10 Globe
11 Opening
20, 20D, 20E, 220, 220A, 620 LED module
21, 21D, 21E, 621 Base board
   22 LED
   22a Sapphire board
   22b Nitride semiconductor layer
   22c Cathode electrode
   22d Anode electrode
   22e, 22f Wire bonding portion
   22g Gold wire
   22h Chip bonding material
   23, 23D, 23E, 623 Sealing member
   24, 24D, 24E Power supply terminal
   25 Sintered-material film
   26 Groove
   27 Phosphor-containing resin
   30, 630 Base
   31 Screw
   32 Eyelet
   40, 640 Stem
   50, 80 Lead wire
   60 Lighting circuit
   70, 70A, 70B, 70C, 70D, 70E, 70F Heat sink
   71A Heat dissipation fin
   71B Wide-width part
   71C Heat sink portion
   72B Rod-shaped portion
   73D Groove
   100, 200, 300, 300A, 300B, 300C, 300D, 300E, 300F, 600 Lamp
   400 Lighting apparatus
   420 Lighting equipment
   421 Equipment body
   421a Socket
   422 Lamp cover
   500 Ceiling
   610 Outer member
   631 Base pin
   670 Board
   691 Holding member
   692 Heat shield

1. A lamp in which gas is enclosed, the lamp comprising:
a housing;
a light-emitting module which is housed in the housing and includes a base board and a semiconductor light-emitting device disposed on the base board; and
a lead wire which supplies power to the light-emitting module and holds the light-emitting module in midair,
wherein the gas is enclosed in the housing, the gas surrounding the light-emitting module and containing at least one of hydrogen, helium, and nitrogen.

2. The lamp according to claim 1,
wherein the base board is translucent.

3. The lamp according to claim 1, further comprising
a sealing member which seals the semiconductor light-emitting device,
wherein the sealing member includes a first wavelength conversion material for converting a wavelength of light emitted by the semiconductor light-emitting device to a predetermined wavelength.

4. The lamp according to claim 3, further comprising
a wavelength conversion member for converting the wavelength of the light emitted by the semiconductor light-emitting device to the predetermined wavelength,
wherein the wavelength conversion member is formed on a surface of the base board opposite a surface on which the semiconductor light-emitting device is disposed.

5. The lamp according to claim 4,
wherein the wavelength conversion member is a sintered-material film, and
the sintered-material film includes (i) a second wavelength conversion material for converting a wavelength of light transmitted through the base board among the light emitted by the semiconductor light-emitting device to the predetermined wavelength and (ii) a binder for sintering made of an inorganic material.

6. The lamp according to claim 4, further comprising
a groove formed on the surface of the base board on which the semiconductor light-emitting device is disposed, the groove holding a third wavelength conversion material for converting the wavelength of the light emitted by the semiconductor light-emitting device to the predetermined wavelength.

7. The lamp according to claim 1, further comprising
a heat sink fixed to the base board.

8. The lamp according to claim 7,
wherein the base board is provided standing on the heat sink.

9. The lamp according to claim 7,
wherein the base board includes a plurality of base boards.

10. The lamp according to claim 7,
wherein the heat sink is fixed to a surface of the base board opposite a surface on which the semiconductor light-emitting device is disposed.

11. The lamp according to claim 10, further comprising
a power receiving unit configured to receive power for causing the light-emitting module to emit light,
wherein the heat sink extends toward the power receiving unit.

12. The lamp according to claim 10,
wherein the heat sink includes a heat dissipation fin.

13. The lamp according to claim 7,
wherein the heat sink is translucent.

14. The lamp according to claim 1,
wherein the lamp is a light bulb shaped lamp.

15. The lamp according to claim 1,
wherein the lamp is a straight-tube lamp, further comprising
a supporting member which supports the light-emitting module.

16. A lighting apparatus comprising
the lamp according to claim 1.
